(19) United States
(12) Patent Application Publication
(10) Pub. No.: US 2007/0197185 A1
(43) Pub. Date: Aug. 23, 2007

(54) System and method for reducing odd harmonic mixing in broadband tuners

(75) Inventor: John Thomas Bayruns, Bridgewater, NJ (US)

Correspondence Address: WILLIAM L BOTJER, P O BOX 478, CENTER MORICHES, NY, 11934, US

(73) Assignee: Anadigics, Inc.

(21) Appl. No.: 11/360,548

(22) Filed: Feb. 23, 2006

(51) Int. Cl. H04B 1/26

(52) U.S. Cl. 455/326

(57) ABSTRACT

The invention provides a broadband tuner with a reduced odd harmonic mixing and a method for reducing odd harmonic mixing in the broadband tuner. The broadband tuner includes an arrangement of one or more filters, a plurality of mixers and one or more adders. The plurality of mixers mix a plurality of input Radio Frequency (RF) signals with one or more Local Oscillator (LO) signals, to generate a plurality of mixing products. The LO signals may be square wave LO signals with predefined amplitude coefficients and phases. The plurality of mixing products are then added by the adders to reduce mixing of the odd harmonics of the LO signals.

### BACKGROUND OF THE INVENTION

1. Field of the Invention

The invention relates generally to the field of broadband tuners, and more specifically, to reducing odd harmonic mixing in broadband tuners.

2. Description of the Related Art

Broadband tuners, such as TV tuners, select a range of Radio Frequency (RF) signals from input RF signals and translate the selected RF signals to an RF signal at an Intermediate Frequency (IF), hereinafter referred to as an IF signal. A broadband tuner includes one or more mixers, one or more local oscillators, and one or more filters. The selected RF signals are translated to the IF signal by mixing the selected RF signals with one or more Local Oscillator (LO) signals, in the one or more mixers. The one or more filters may be used to remove unwanted signals from the input RF signals and the IF signal.

However, one or more of the selected RF signals may mix with the harmonics of the LO signals to produce one or more signals at IF. These signals at IF produce interfering signals at the output of the broadband tuner, thereby reducing the signal to noise ratio of the selected RF signals.

Existing broadband tuners for reducing harmonic mixing include a single-conversion tuner with an input-tracking filter, a single-conversion tuner with a double quadrature mixer, and the like. The single-conversion tuner with an input-tracking filter includes a variable-input bandpass filter. The variable-input bandpass filter tracks a required frequency in the input RF signals and removes one or more RF signals at harmonic mixing frequencies from the input RF signal. The single-conversion tuner with a double quadrature mixer includes an input polyphase filter, a quadrature local oscillator, and a switched RF filter. The input polyphase filter generates in-phase (I) and quadrature-phase (Q) paths from each of the input RF signals. The quadrature local oscillator generates I and Q LO signals. Output of the single-conversion tuner with a double quadrature mixer is generated by matching the I and Q paths of the input RF signals with the I and Q LO signals, such that the mixing of the third harmonic of the LO signals is reduced. The mixing of the higher order harmonics of the LO signals is reduced by using switched RF filters.

In another approach, it has been suggested to use a double double-balanced mixer. The double double-balanced mixers offer a high input compression point performance with a broad frequency range. Though the double double-balanced mixers inherently reject even-harmonic mixing, they leave mixing of the odd harmonic unaddressed.

Additionally, existing broadband tuners require manual tuning during the manufacturing process, to achieve a good match between a variable-input bandpass filter and an LO signal frequency. For example, the existing tuners need an extremely good matching between the RF filter and the LO signal frequency to work effectively. Accordingly, manual tuning of these tuners is required at the manufacturing stage, the complexity of which is driven by the fact that the tuning is provided by wire wound coils, which make the integration of the tuners difficult. In the simplest cases, the tuning may include adjusting the impedance of the circuit so as to adjust the resonant frequencies of the filter circuits according to the desired range of the RF signals. Further, the use of input polyphase filters and switched RF filters to decrease the linearity of the broadband tuners and to reduce the signal to noise ratio has been suggested. However, the use of these input polyphase filters and the switched RF filters reduces signal strength.

In light of the foregoing discussion, there is a need for a broadband tuner that reduces the mixing of the odd harmonics (i.e., the 1^{st}, 3^{rd}, 5^{th} harmonics, etc.) of LO signals, without requiring manual tuning while the broadband tuners are being manufactured. Further, the broadband tuner should provide high linearity and a high signal to noise ratio

### SUMMARY OF THE INVENTION

An object of the invention is to reduce the mixing of the odd harmonics of Local Oscillator (LO) signals in broadband tuners.

Another object of the invention is to reduce the mixing of the odd harmonics of the LO signals in the broadband tuners, without requiring manual tuning while the broadband tuners are being manufactured.

Yet another object of the invention is to reduce the mixing of the odd harmonics of the LO signals in the broadband tuners, providing high linearity and a high signal to noise ratio in the broadband tuners.

To achieve the objectives stated above, various embodiments of the invention provide a broadband tuner having unique mixer architecture, and a method for reducing odd harmonic mixing in the broadband tuner. In accordance with an embodiment of the invention, the broadband tuner includes a plurality of mixers and one or more adders. The plurality of mixers mix a plurality of Radio Frequency (RF) signals with one or more LO signals and generate a plurality of mixing products. Herein, the LO signals are square wave LO signals with predefined amplitude coefficients and phases. The adders add the plurality of mixing products to generate one or more RF signals at an Intermediate Frequency (IF), such that the mixing of the odd harmonics of the LO signals is reduced. In an embodiment of the invention, the broadband tuner includes one or more filters to remove unwanted signals from the plurality of RF signals.

In accordance with another embodiment of the invention, the method includes mixing a plurality of RF signals with one or more LO signals to generate a plurality of mixing products. Herein, the LO signals are square wave LO signals with predefined amplitude coefficients and phases, in an embodiment of the invention in the form of square wave doublets. The method further includes adding the plurality of mixing products such that the mixing of the odd harmonics of the LO signals is reduced.

Various embodiments of the invention provide a broadband tuner for reducing odd harmonic mixing, which does not require manual tuning during the manufacturing process. The broadband tuner reduces the odd harmonic mixing of the LO signals without using filters after mixing the RF signals with the LO signals. The broadband tuner has a high linearity and provides a high signal to noise ratio. Moreover, the broadband tuner may be utilized in the analog as well as the digital domain.

### BRIEF DESCRIPTION OF THE DRAWINGS

So that the manner in which the above recited features of the present invention can be understood in detail, a more particular description of the invention, briefly summarized above, may be had by reference to various embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a broadband tuner;

FIG. 2 is a block diagram illustrating a broadband tuner for reducing odd harmonic mixing, including a composite mixer, in accordance with an embodiment of the invention;

FIG. 3 is a block diagram illustrating a system including a composite mixer for reducing odd harmonic mixing, in accordance with another embodiment of the invention; and

FIG. 4 is a flowchart of a method for reducing odd harmonic mixing in a broadband tuner, in accordance with an embodiment of the invention.

### DETAILED DESCRIPTION

Various embodiments of the invention provide a broadband tuner with a reduced odd harmonic mixing, and a method for reducing odd harmonic mixing. The broadband tuner includes one or more filters, a plurality of mixers, and one or more adders. The one or more filters remove unwanted signals from a plurality of input Radio Frequency (RF) signals received by the broadband tuner. The plurality of mixers mix the filtered RF signals with one or more Local Oscillator (LO) signals provided by a local oscillator, and generate a plurality of mixing products. Herein, the LO signals are square wave LO signals with predefined amplitude coefficients and phases. The adders add the plurality of mixing products to produce one or more RF signals at an Intermediate Frequency (IF), hereinafter referred to as IF signals, such that a selected range of RF signals from the input RF signals associated with the fundamental frequency of the LO signals are retained and ranges of the RF signals associated with the odd harmonics of the LO signals are rejected.

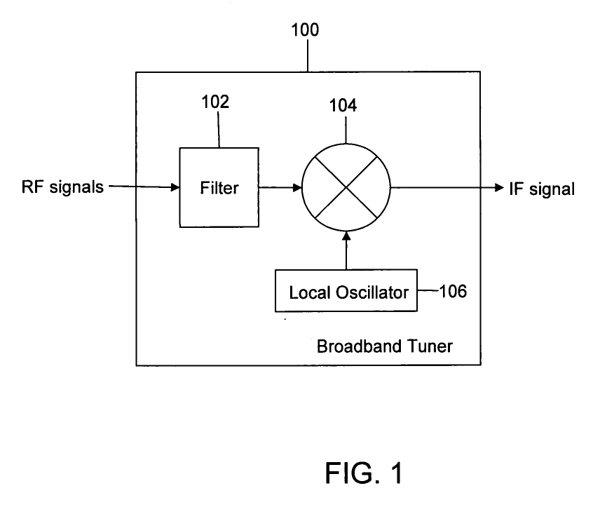

FIG. 1 is a block diagram illustrating a broadband tuner 100. Broadband tuner 100 translates a plurality of RF signal to an IF signal. Herein, the plurality of RF signals include the RF signals with frequencies in a predefined range. Broadband tuner 100 includes a filter 102, a mixer 104, and a local oscillator 106. Filter 102 receives an input RF signal and removes unwanted signals. The unwanted signals may include signals with frequencies substantially higher than the predefined frequency range, interfering signals with frequencies in the predefined frequency range, and the like. Only the RF signals with frequencies in the predefined range may pass through filter 102. Mixer 104 mixes the filtered RF signals with one or more LO signals, generated by local oscillator 106, such that the mixing of the odd harmonics of the LO signals is reduced. The output of composite mixer 104 is the IF signal.

Broadband tuner 100 may be used as a television (TV) tuner. The RF signals may include broadband signals. Typically, the input RF frequency band for such tuners extends between 57 and 860 MHz, and can go as high as 1100 MHz. Further, the RF signals may be digital or analog signals. The RF signals may be supplied through a community access television (CATV) infrastructure.

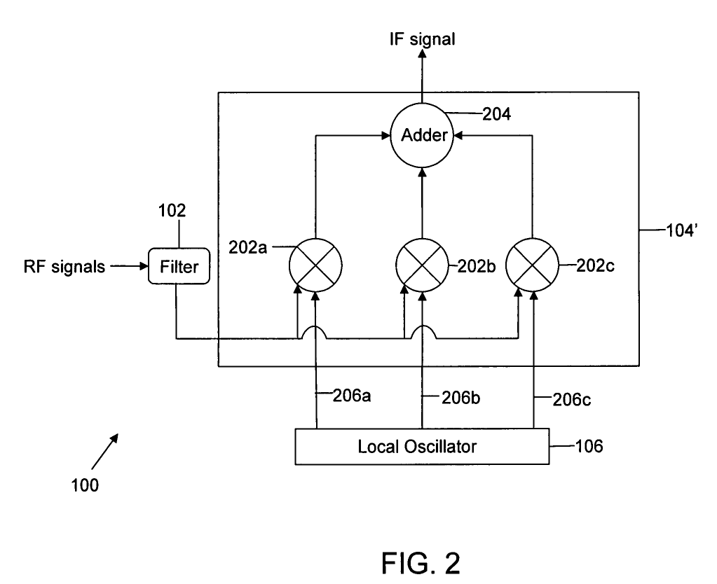

FIG. 2 is a block diagram illustrating a composite mixer 104′ which may be used with a broadband tuner, in which odd harmonic mixing is reduced, in accordance with an embodiment of the invention. A plurality of input RF signals are received by a broadband tuner, such as, broadband tuner 100.

A filter, such as filter 102, removes the unwanted signals from the input RF signals, to generate a plurality of filtered RF signals. A local oscillator, such as local oscillator 106, produces one or more LO signals. Herein, the LO signals are square wave LO signals with predefined amplitude coefficients and phases.

Composite mixer 104′ includes a plurality of mixers, such as mixers 202a, 202b and 202c, and an adder 204. Composite mixer 104′ receives the filtered RF signals and one or more square wave LO signals, such as square wave LO signals 206a, 206b and 206c. Mixers 202a, 202b and 202c mix square wave LO signals 206a, 206b and 206c, respectively, with the filtered RF signals to generate a plurality of mixing products. Adder 204 adds the mixing products to produce an IF signal such that the mixing of the odd harmonics of square wave LO signals 206a, 206b, and 206c is reduced. Output of adder 204 is the IF signal.

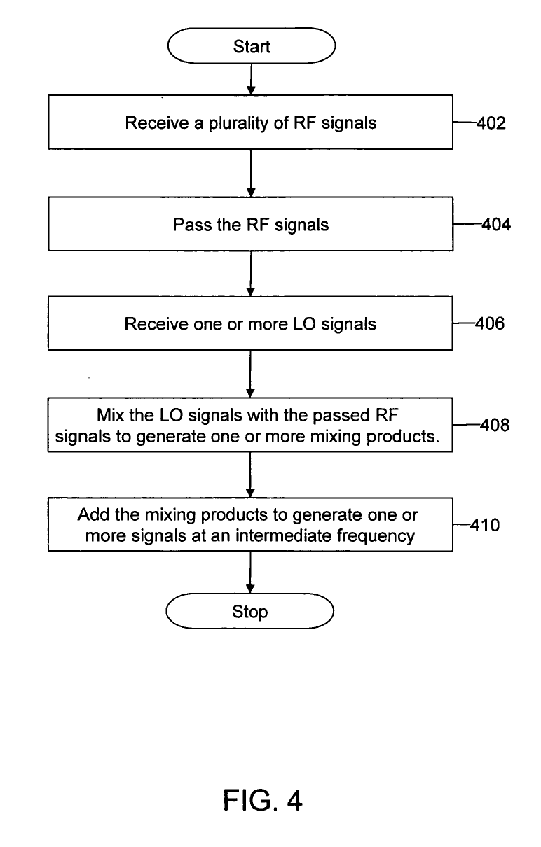

In accordance with an embodiment of the invention, square wave LO signals 206a, 206b and 206c have amplitude coefficients α, β, and γ, respectively. Further, square wave LO signals 206a, 206b and 206c may have the same frequency but different phases. The amplitude coefficients and phases of square wave LO signals 206a, 206b and 206c are determined by using predefined criteria explained in detail in conjunction with FIG. 4.

In accordance with another embodiment of the invention, square wave LO signals 206a, 206b and 206c may have the same amplitude coefficients. In such a case, mixers 202a, 202b and 202c mix square wave LO signals 206a, 206b and 206c, respectively, with the filtered RF signals to generate the plurality of mixing products. Thereafter, mixers 202a, 202b, and 202c may combine amplitude coefficients α, β, and γ to the mixing products of square wave LO signals 206a, 206b and 206c, respectively. Herein, values of α, β, and γ are calculated using the predefined criteria.

In accordance with an embodiment of the invention, mixers 202a, 202b, and 202c may be, for example, in-phase/quadrature-phase (I/Q) mixers.

In accordance with an embodiment of the invention, filter 102 removes the RF signals with frequencies that may mix with the 15^{th} or higher order harmonics of the LO signals to produce the IF signal. Filter 102 may be a polyphase filter, a band pass filter or a Surface Acoustic Wave (SAW) filter. In accordance with an embodiment of the invention, broadband tuner 100 may include one or more filters, which may be, for example, coupled to composite mixer 104′. Herein, the filters may be used, for example, to remove the interfering signals at IF.

In accordance with various embodiments of the invention, composite mixer 104′ may be an active or a passive mixer.

In accordance with an embodiment of the invention, local oscillator 106 is a multi-octave local oscillator. Further, the LO signals produced by local oscillator 106, are square wave LO signals. The amplitude coefficients and the phases of the square wave LO signals may be determined according to predefined criteria, which are explained in detail in conjunction with FIG. 4.

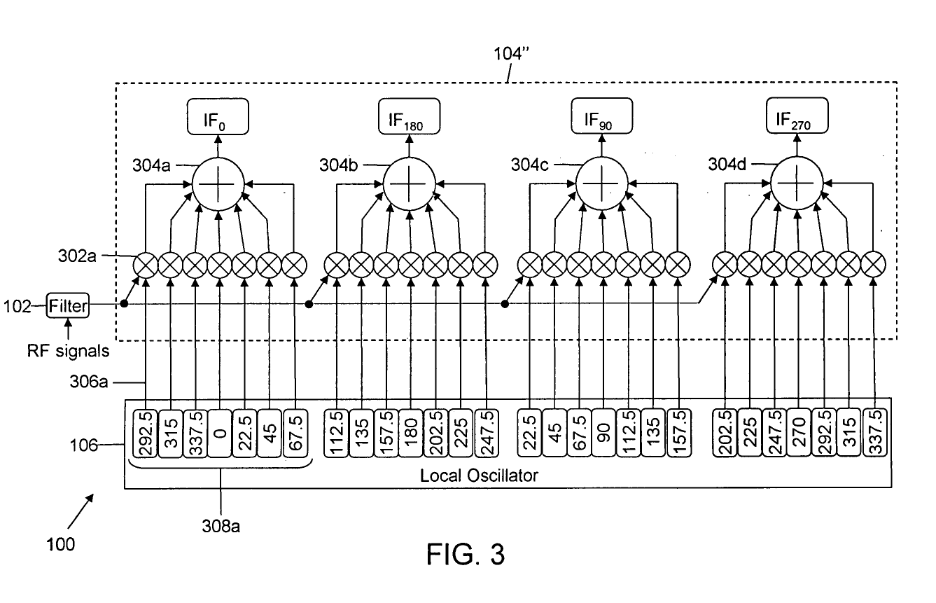

FIG. 3 is a block diagram illustrating a composite mixer 104″ for reducing odd harmonic mixing in broadband tuner 100, in accordance with another embodiment of the invention. Composite mixer 104″ receives a plurality of filtered RF signals from one or more filters, such as filter 102, and translates the filtered RF signals to one or more IF signals. Composite mixer 104″ includes 28 mixers, such as a mixer 302a, and four adders, such as adders 304a, 304b, 304c and 304d. Herein, mixer 302a is similar to mixer 202a, and each of adders 304a, 304b, 304c and 304d is similar to adder 204a. Further, the 28 mixers are similar in nature and type. Herein, each of the 28 mixers receives a filtered RF signal and an LO signal. For illustration purposes, only selected mixers are shown as receiving the filtered RF signal.

A local oscillator, such as local oscillator 106, produces 28 square wave LO signals, such as, a square wave LO signal 306a. The 28 square wave LO signals are included in four groups, such as a group 308a. Each of these groups includes seven square wave LO signals. For example, group 308a includes seven square wave LO signals with amplitude coefficients α, β, γ, 1, γ, β, and α. In accordance with an embodiment of the invention, the seven square wave LO signals have different phases, the values of phases being multiples of 22.5. For example, in group 308a, the seven square wave LO signals with amplitude coefficients α, β, γ, 1, γ, β, and α, have phases 22.5, 45, 67.5, 0, 292.5, 315, and 337.5, respectively. Each of the seven square wave LO signals is directed to one of the 28 mixers, such as mixer 302a. The production of the seven square wave LO signals, and subsequent reduction of odd harmonics of the square wave LO signals is explained in detail in conjunction with FIG. 4.

Thereafter, each of the 28 mixers mixes the filtered RF signals with one of the 28 square wave LO signals, to produce a mixing product. Hence, the 28 mixers mix the filtered RF signals with the 28 square wave LO signals to produce 28 mixing products. Each of the four adders adds seven mixing products. For example, adder 304a adds seven mixing products, which are generated by mixing the seven square wave LO signals of group 308a, with the filtered RF signals. Adders 304a, 304b, 304c and 304d, add the 28 mixing products such that the mixing of the odd harmonics of the 28 square wave LO signals is reduced. The output of each of the four adders is an IF signal. In accordance with an embodiment of the invention, adders 304a, 304b, 304c and 304d, add I and Q paths of the 28 mixing products, so as to generate four IF signals, which are in quadrature with respect to each other. The four IF signals are IF₀, IF₁₈₀, IF₉₀ and IF₂₇₀. These four IF signals may be combined to form a single IF signal or may be used in quadrature depending upon the end use of broadband tuner 100.

Each of adders 304a, 304b, 304c and 304d requires seven mixing products to generate an IF signal, such as IF₀. Further, four IF signals IF₀, IF₁₈₀, IF₉₀ and IF₂₇₀, in quadrature with respect to each other, are generated. Therefore, composite mixer includes 28 mixers.

It may be evident to a person skilled in the art that local oscillator 106 may be replaced by a plurality of local oscillators (each similar to local oscillator 106), to produce the 28 square wave LO signals, without deviating from the scope of the invention. In another case, local oscillator 106 may include one or more phase-shifters to produce the 28 square wave LO signals with different phases.

In accordance with an embodiment of the invention, two or more square wave LO signals, of the same or separate groups, may have the same amplitude coefficients or phases

In accordance with an embodiment of the invention, various elements such as the 28 mixers, and adders 304a, 304b, 304c and 304d, are designed by utilizing standard analog design techniques such as Simulation Program with Integrated Circuit Emphasis (SPICE) techniques.

In accordance with another embodiment of the invention, various elements such as the 28 mixers and the four adders, such as adders 304a, 304b, 304c and 304d, are designed by utilizing standard complementary metal-oxide semiconductor (CMOS) technology.

FIG. 4 is a flowchart of a method for reducing odd harmonic mixing in a broadband tuner, in accordance with an embodiment of the invention. A plurality of input RF signals are translated to one or more IF signals by mixing the input RF signals with one or more LO signals in the broadband tuner.

At step 402, the input RF signals are received by a broadband tuner, such as broadband tuner 100. At step 404, the input RF signals are passed using a filter, such as filter 102. At step 406, one or more LO signals are received. The LO signals are square wave LO signals with predefined amplitude coefficients and phases. In accordance with an embodiment of the invention, the LO signals have the same frequency.

At step 408, the LO signals are mixed with the filtered RF signals. The mixing of the LO signals with the filtered RF signals generates a plurality of mixing products. At step 410, the mixing products are added to generate one or more IF signals, such that the mixing of the odd harmonics of the LO signals is reduced.

In accordance with an embodiment of the invention, it has been found that all the odd harmonics, till 13^{th} harmonic of the LO signals, are reduced by adding the mixing products. It should be appreciated that instead of the three doublets described in conjunction with each of the mixer clusters, additional doublets could be added to eliminate higher order harmonics, such as the 15^{th} and 17^{th}, and beyond. In accordance with another embodiment of the invention, the 15^{th}, 17^{th} and higher harmonics of the LO signals may be reduced by using a filter, such as filter 102. In particular, filter 102 may be used to remove the high frequency RF signals that may mix with the 15^{th} and 17^{th} harmonics of the LO signals to produce interfering signals at IF. In accordance with an embodiment of the invention, filter 102 may be a SAW filter that, while incapable of removing the lower order odd harmonics, such as the 13^{th} and lower, is capable of removing a substantial portion of the high frequency RF signals, such as those above the 15^{th} odd harmonic.

In accordance with an embodiment of the invention, the mathematical equations used for determining the amplitude coefficients of the square wave LO signals and the mathematical equations depicting the reduction of the mixing of the odd harmonics of the square wave LO signals may be represented as follows. The following set of mathematical equations describe the specific embodiment of FIG. 3 but similar mathematical equations may be derived for different combinations of phases and amplitude coefficients of the square wave LO signals.

A sinusoid LO signal, which may be produced by local oscillator 106, may be represented by a Fourier series:
f_{LO}(ωt)=A. cos(ωt) (1)

In equation (1), A is the amplitude coefficient and ω is the angular frequency of the sinusoid LO signal.

The sinusoid LO signal may be represented as the sum of a square wave LO signal and one or more doublets. Each of the doublets includes summation of two square wave signals. The two square wave signals of each doublet have positive and negative phase terms, respectively, of equal magnitudes.

The Fourier series representing a square wave LO signal is:

$${f}_{SQW} ( ω t , ϕ ) = {\sum }_{n = 1 , 3 , 5 , …}^{∞} \frac{tan ( n \cdot π / 4 ) \cdot cos ( n \cdot ω t + n \cdot ϕ )}{n} \qquad ( 2 )$$

A doublet of, for example, the square wave LO signal of equation (2) may be represented as:

$$\begin{matrix}{f}_{DBLT} ( ω t , ϕ ) = {f}_{SQW} ( ω t , ϕ ) + {f}_{SQW} ( ω t , - ϕ ) & ( 3 ) \\ {f}_{DBLT} ( ω t , ϕ ) = {\sum }_{n = 1 , 3 , 5 , …}^{∞} \frac{tan ( n \cdot π / 4 ) \cdot cos ( n \cdot ϕ ) \cdot cos ( n \cdot ω t )}{n} & ( 4 )\end{matrix}$$

Therefore, the sinusoid LO signal may be generated, for example, by adding a square wave LO signal, with φ=0, to doublets with φ=22.5 degrees (π/8 radians), φ=45 degrees (π/4 radians) and φ=67.5 degrees (3π/8 radians). Hence, the square wave LO signal and the three doublets form seven square wave LO signals that may be combined to generate the sinusoid LO signal.

In accordance with an embodiment of the invention, the amplitude coefficient of the square wave LO signal has a value equal to one. The doublets with φ=22.5 degrees, φ=45 degrees, and φ=67.5 degrees have amplitude coefficients, α, β, and γ, respectively. The sinusoid LO signal, may be represented as the sum of the square wave LO signal and the doublets, as follows.

$$\begin{matrix}{f}_{LO} ( ω t ) = {f}_{SQW} ( ω t , 0 ) + α \cdot {f}_{DBLT} ( ω t , π / 8 ) + β \cdot {f}_{DBLT} ( ω t , π / 4 ) + γ \cdot {f}_{DBLT} ( ω t , 3 π / 8 ) & ( 5 ) \\ {f}_{LO} ( ω t ) = {\sum }_{n = 1 , 3 , …}^{∞} \frac{tan ( n \cdot π / 4 ) \cdot cos ( n \cdot ω t )}{n} \cdot [ \begin{matrix}\begin{matrix}1 + 2 αcos ( n \cdot π / 8 ) + \\ 2 βcos ( n \cdot π / 4 ) +\end{matrix} \\ 2 γcosβ ( 3 n \cdot π / 8 )\end{matrix} ] & ( 6 )\end{matrix}$$

Equation (6) represents the sum of the seven square wave LO signals. Herein, each of the seven square wave LO signals has the same frequency as the sinusoid LO signal.

The values of amplitude coefficients α, β and γ may be determined by applying the following conditions:
f_{LO}(ωt)|ₙ₌₁=A. cos(ωt) (7)
f_{LO}(ωt)|ₙ₌₃=0 (8)
f_{LO}(ωt)|ₙ₌₅=0 (9)
f_{LO}(ωt)|ₙ₌₇=0 (10)

The equations (8), (9) and (10) are used to ensure the reduction of the mixing of the odd harmonics of the sinusoid LO signal. Solving equation (6), in conjunction with equations (7), (8), (9) and (10), we get:

$$\begin{matrix}α = cos ( π / 8 ) & ( 11 ) \\ β = \frac{1}{2 cos ( π / 4 )} & ( 12 ) \\ γ = cos ( 3 π / 8 ) & ( 13 )\end{matrix}$$

Hence, the sinusoid LO signal may be represented by sum of seven square wave LO signals with amplitude coefficients γ, β, α, 1, α, β and γ.

In the aforementioned mathematical equations, the amplitude coefficients of the seven square wave LO signals are derived by using assumed valued of the phases. Other approaches may also be used to derive the phases and amplitude coefficients of the seven square wave LO signals.

In accordance with an embodiment of the invention, a local oscillator, such as local oscillator 106, may be used to generate one or more square wave LO signals, which are included in one or more groups, such as a group 308a. Each group includes seven square wave LO signals. The amplitude coefficients and phases of the seven square wave LO signals may be calculated by using the aforementioned mathematical equations.

Equation (6) represents the sum of the seven square wave LO signals. The mixing of the odd harmonics of the sinusoid LO signal is reduced, as the sum represented by equation (6) becomes zero for the odd harmonics of the sinusoid LO signals. It may be evident to a person skilled in the art that since the seven square wave LO signals have the same frequency as the sinusoid LO signal, the harmonics of the seven square wave LO signals and the sinusoid LO signal represent the same frequencies.

Using equation (6), the Fourier series for the third harmonic of the sinusoid LO signal may be represented as:

$${f}_{LO} ( ω t ) {\vert}_{n = 3} = \frac{tan ( 3 π / 4 ) cos ( 3 ω t )}{3} \cdot [ \begin{matrix}\begin{matrix}1 + 2 αcos ( 3 π / 8 ) + \\ 2 βcos ( 3 π / 4 ) +\end{matrix} \\ 2 γcos ( 9 π / 8 )\end{matrix} ] \qquad ( 14 )$$

By solving the equation, we get (15)

$$\begin{matrix}{f}_{LO} ( ω t ) {\vert}_{n = 3} = \frac{- cos ( 3 ω t )}{3} \cdot [ \begin{matrix}\begin{matrix}1 + 2 ( cos ( π / 8 ) ) cos ( 3 π / 8 ) - \\ 2 ( \frac{1}{2 cos ( π / 4 )} ) cos ( π / 4 ) -\end{matrix} \\ 2 ( cos ( 3 π / 8 ) ) cos ( π / 8 )\end{matrix} ] & ( 15 ) \\ {f}_{LO} ( ω t ) {\vert}_{n = 3} = 0. & ( 16 )\end{matrix}$$

Hence, the mixing of the third harmonic of the sinusoid LO signal is reduced. The mixing of the fifth harmonic of the sinusoid LO signal may also be reduced as shown in the equations below.

Using equation (6), the Fourier series for the fifth harmonic of the sinusoid LO signal may be represented as:

$${f}_{LO} ( ω t ) {\vert}_{n = 5} = \frac{tan ( 5 π / 4 ) cos ( 5 ω t )}{5} \cdot [ \begin{matrix}\begin{matrix}1 + 2 αcos ( 5 π / 8 ) + \\ 2 βcos ( 5 π / 4 ) +\end{matrix} \\ 2 γcos ( 15 π / 8 )\end{matrix} ] \qquad ( 17 )$$

By solving the equation, we get:

$$\begin{matrix}{f}_{LO} ( ω t ) {\vert}_{n = 3} = \frac{cos ( 5 ω t )}{5} \cdot [ \begin{matrix}\begin{matrix}1 - 2 ( cos ( π / 8 ) ) cos ( 3 π / 8 ) - \\ 2 ( \frac{1}{2 cos ( π / 4 )} ) cos ( π / 4 ) +\end{matrix} \\ 2 ( cos ( 3 π / 8 ) ) cos ( π / 8 )\end{matrix} ] & ( 18 ) \\ {f}_{LO} ( ω t ) {\vert}_{n = 5} = 0 & ( 19 )\end{matrix}$$

Similarly, the mixing of the seventh, ninth, eleventh and thirteenth harmonics of the sinusoid LO signal may be reduced.

In accordance with another embodiment of the invention, a square LO signal may also be represented as sum of a plurality of square wave LO signals, using the aforementioned mathematical equations.

In accordance with another embodiment of the invention, local oscillator 106 produces seven square wave LO signals with equal amplitude coefficients. The seven square wave LO signals are mixed with the filtered RF signals to generate seven mixing products. Thereafter, the amplitude coefficients calculated using the aforementioned mathematical equations are multiplied to the mixing products of the corresponding square wave LO signal. The mixing products are then added such that the mixing of the odd harmonics of the square wave LO signals is reduced.

In accordance with an embodiment of the invention, the broadband tuner, such as broadband tuner 100, employing the composite mixer of this invention and the method as described in conjunction with FIG. 2, FIG. 3 and FIG. 4 may be utilized in a broadband digital signal system. In an alternative embodiment of the invention, the broadband tuner and the method as described in conjunction with FIG. 2, FIG. 3, and FIG. 4 may be utilized in a broadband analog signal system.

The method and the broadband tuner described above have a number of advantages. The broadband tuner reduces the odd harmonic mixing of LO signals without requiring manual tuning during the manufacturing. Further, filters are not required to filter mixing products of the filtered RF signals and the LO signals, thereby increasing the linearity of the broadband tuner and the signal to noise ratio.

While the foregoing is directed to embodiments of the present invention, other and further embodiments of the invention may be devised without departing from the basic scope thereof, and the scope thereof is determined by the claims that follow.

1. A broadband tuner, the broadband tuner receiving a plurality of Radio Frequency (RF) signals, the broadband tuner translating the plurality of RF signals to one or more Intermediate Frequency (IF) signals, the broadband tuner comprising:
one or more filters, the one or more filters passing at least one of the plurality of RF signals;
a plurality of mixers, the plurality of mixers mixing the plurality of RF signals with one or more square wave Local Oscillator (LO) signals; and
one or more adders, the one or more adders adding outputs generated by the plurality of mixers, the adding reducing mixing of odd harmonics up to 13th harmonic of the one or more square wave LO signals.

2. The broadband tuner of claim 1, wherein each of the one or more square wave LO signals has predefined amplitude coefficient and phase.

3. The broadband tuner of claim 1, wherein each of the plurality of mixers combine a predefined amplitude coefficient to the output generated by the mixing.

4. The broadband tuner of claim 1, wherein the plurality of mixers and the one or more adders are designed using standard analog design techniques.

5. The broadband tuner of claim 1, wherein the plurality of mixers and the one or more adders are designed using standard Complementary Metal-Oxide Semiconductor (CMOS) technology.

6. A broadband digital signal system utilizing the broadband tuner of claim 1.

7. A broadband analog signal system utilizing the broadband tuner of claim 1.

8. A broadband tuner, the broadband tuner receiving a plurality of Radio Frequency (RF) signals, the broadband tuner translating the plurality of RF signals to one or more Intermediate Frequency (IF) signals, the broadband tuner comprising:
one or more filters, the one or more filters passing at least one of the plurality of RF signals;
28 mixers, the 28 mixers mixing the plurality of RF signals with 28 square wave Local Oscillator (LO) signals; and
Four adders, the four adders adding outputs generated by the 28 mixers, the four adders producing four IF signals, the adding reducing mixing of odd harmonics up to 13th harmonic of the one or more square wave LO signals.

9. The broadband tuner of claim 8, wherein each of the 28 square wave LO signals has predefined amplitude coefficient and phase.

10. The broadband tuner of claim 8, wherein at least two of the four IF signals are in quadrature with each other.

11. A method for reducing odd harmonic mixing in a broadband tuner, the broadband tuner receiving a plurality of Radio Frequency (RF) signals, the broadband tuner translating the plurality of RF signals to an Intermediate Frequency (IF) signal, the method comprising the steps of:
mixing the plurality of Radio Frequency (RF) signals with one or more square wave Local Oscillator (LO) signals, the mixing generating a plurality of outputs; and
adding the plurality of outputs, the adding reducing mixing of odd harmonics up to 13th harmonic of the one or more square wave LO signals.

12. The method of claim 11 further comprising the step of passing at least one of the plurality of RF signals through a filter prior to mixing.

13. The method of claim 11, wherein each of the one or more square wave LO signals has predefined amplitude coefficient and phase.
